(19) United States
(12) Patent Application Publication
(10) Pub. No.: US 2007/0196153 A1
(43) Pub. Date: Aug. 23, 2007

(54) Lenticular printer

(75) Inventor: Itzhak Bar Yona, Rosh Ha'Ayin (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: LUBARTECH LTD., Omer (IL)

(21) Appl. No.: 10/575,503

(22) PCT Filed:
(86) PCT No.: PCT/IL04/00948

(30) Foreign Application Priority Data
Oct. 16, 2003 (IL) 158458

(51) Int. Cl. B41J 5/30

(52) U.S. Cl. 400/62

(57) ABSTRACT

Method and system for obtaining automatic alignment of interlaced images to a lenticular sheet and adaptation between the pitch distance thereof. An interlaced file that includes digital data that comprises linear orientation and pitch distance data and corresponds to linear frames of two different images is obtained. A lenticular sheet is provided on the flat face of which the at least two different images are intended to be printed, while obtaining linear orientation and pitch distance thereof. The digital data of the interlaced file is modified, so that the orientation and pitch distance of the linear frames match the orientation and pitch distance of the lenticular sheet. Then the modified digital data is printed on the lenticular sheet.

### FIELD OF THE INVENTION

The present invention is related to the field of printing. More specifically the present invention is related to stereoscopic images made by utilizing lenticular technology. Still more specifically, the present invention is related to a method for precisely obviating deviations related to alignment and pitch distance between interlaced images and lenticular sheet prior to the printing of the interlaced images on the lenticular sheet.

### BACKGROUND OF THE INVENTION

There is a growing need in the graphic and design studios, as well as for desktop applications, for sophisticated visual effects, that will allow, e.g., an advertiser, exploiting one display means for displaying several different pictures, each of which is intended to be seen from a different angle with respect to the plane of the display means. Sophisticated visual effects are currently obtainable thanks to continuous improvements in the printing industry, and in particular, improvements that involve computerized image processing techniques that are based on, e.g., Digital Image Processing (DIP). Such visual effects involve, for example, obtaining an illusion of a three-dimensional (3D) picture from two-dimensional (2D) pictures, by utilizing one of the interlacing software packages that are readily available on the market (e.g., “Shuffle” of “Streoscopic Scanning”, and “Impactio” of “HumanEyes”), which allow interlacing images that are generated from several pictures, or from different images of the same object that are seen from different angles, depending on the required visual effect. The interlaced images are then stored in a corresponding file (hereinafter referred to as the “Interlaced File”), which is afterwards printed on a corresponding lenticular sheet. Common types of files, which work best for lenticular imaging, are “Photoshop” files and “.TIF” files.

The word “lenticular” refers to an array of repeated, identical line-like lenses that are known as lenticules. A lenticule is, therefore, a single line-like lens in the lenticular array, that is made from durable plastics, such as PVC, PETG and Acrylic. This term, however, also extends to non-linear lens arrays, made as circular lenses, etc.

By “Interlacing” it is meant that a number of ‘strips’ (also known in the art as “linear frames”) are taken from each one of the generated images and merged together, in alternating way. The aim of the interlacing stage is to align a particular picture to the desired lens. For example, if the lens requires 10 strips (the number of strips being dependent on the number of lenticules per inch—‘LPI’), to be taken from each one of the images, the software will merge the first strip of each of the images to make up the first strip of the output picture. Then the software will take the second strip from each of the images and merge them to create the second strip of the final output etc., until the tenth strip. The output picture is then placed, or printed, under the lens and each eye sees, depending on the desired visual effect, a different view. The LPI parameter describes the number of lenticules per inch in a certain lenticular lens, and affects the thickness of the lens and the viewing distance.

The type of the lenticular sheet and interlacing parameters (i.e., that are utilized by the interlacing software) are selected so as to allow the obtention of the required visual effect that depends on, e.g., the distance between the display media and a potential observer, and on the actual angle of sight.

Interlacing techniques are well known to those skilled in the art. One exemplary method for creating an interlaced image comprised of two separate basic images is demonstrated in FIGS. 1 to 5. FIG. 1 shows one basic image, in this case house 1, and FIG. 2 shows a second basic image, automobile 2. In the next step in creating the interlaced image, shown in FIGS. 3 and 4, the sizes of the frames of both basic images are adjusted to be equal, having height H and width W. Each of the basic images is then divided into ‘n’ equal strips having height H and width w, where w=W/n is the pitch of the interlaced image. In the present example, for simplicity and clarity, ‘n’ is chosen to be 20 and the strips of images 1 and 2 are labeled respectively A1-A20 and B1-B20. The resulting composite image 3 is shown in FIG. 5, which illustrates the interlacing procedure. Strips A1-A20 and B1-B20 are compressed in the horizontal direction until their widths are essentially half of their original width. The forty strips of width w/2 are then arranged in the order [A1, B1], [A2, B2,], . . . , [A20, B20] to form the composite interlaced image 3. Image 3 has the same size as each one of the original images, i.e. height H and width W.

Currently, the use of the interlacing techniques is limited to experts, because there is a major problem associated with implementing them, i.e., a lenticular sheet must be meticulously aligned so that each of the aforesaid strips is printed precisely under the right portion of the right lenticule, in order to obtain the required printed visual effect and minimize “ghosting”, deformation and blurring phenomena in the resulting printed picture. The problem lays in the fact that the plane orientation of the lenticular sheet, when put in place for printing, is to some extent rather random, and the strips cannot be, at least in the first attempt, printed such that they are precisely aligned to the lenticules. Another problem is associated with the manufacturing process of lenticular sheets, because of the pitch variations from one batch of lenticular sheets to another which make it difficult for a user to mechanically adjust lenticular sheets to the printing system. Conventional solutions for solving the alignment problem involve the utilization of what might be called a ‘mechanical’ alignment, i.e., the plane orientation of the lenticular sheet is re-aligned while performing several iterations, typically one iteration per print, until the resulting visual effect is satisfactory. In other words, the alignment problem is currently solved by utilizing a ‘trial and error’ process. The pictures file that contains the strips of the corresponding images (i.e., the interlaced file) is printed on a first lenticular sheet, and the resulting visual effect is examined. Since luck is playing a major role in the aforesaid ‘mechanical’ alignment, the probability of relatively large deviation of the lenticular sheet from the required position is relatively high. Therefore, the same interlaced file is printed on a second lenticular sheet, the orientation of which is adjusted prior to the printing, so as to reduce the deviation, or error. This process is repeated iteratively (wasting expensive lenticular sheets in the process) until the resulting visual effect is satisfactory.

Another conventional solution to the alignment problem involves the utilization of fiducial indicium, optical system and mechanical movement arrangement. According to this solution, the fiducial indicium is printed, or attached, onto the lenticular sheet itself or onto the printing media that is intended to be glued onto the lenticular sheet at a later stage, and the optical system emits light at one end and receives at least a portion of the emitted light at a remote end. The optical system identifies the orientation of the lenticular sheet (i.e., with respect to the printing media, or another reference) by sensing the orientation of the fiducial indicium. A controller accepts alignment errors from the optical system and outputs corresponding commands to the mechanical movement arrangement, to provide relative movement between one element (i.e., either the lenticular sheet or the printing media) and the other element, until good alignment is obtained therebetween, after which the printing media (which includes the printed matter) is permanently affixed to the lenticular sheet.

In some cases, the lenticular sheet includes, on its flat side, a special substance on which the interlaced pictures are intended to be printed. In such cases, fiducial indicium is imprinted on the lenticular sheet, and the lenticular sheet is moved with respect to some reference point(s), while utilizing the fiducial indicium to align between the lenticular sheet and the interlaced pictures.

All of the methods described above have not yet provided solutions to the problem of aligning between lenticular sheets and interlaced pictures without providing relative movement between lenticular sheet and the printing media or some known reference.

It is therefore an object of the present invention to provide the automatic alignment between an interlace file and a lenticular sheet on the back of which the interlace file is to be printed, without providing relative movement between the lenticular sheet and the printing media or some other reference.

It is another object of the present invention to obtain more accurate alignment between interlaced images and lenticular sheet than is obtained by performing mechanical alignment.

It is still another object of the present invention to provide means by which a non-skilled person may print good quality interlaced images on lenticular sheets, by using an ordinary (“home standard”) inkjet or the like printer.

Further purposes and advantages of the invention will become apparent as the description proceeds.

### SUMMARY OF THE INVENTION

The present invention provides a method for obviating deviations between interlaced images and a lenticular sheet, which are related to alignment and pitch distances, prior to the printing of the interlaced images on the lenticular sheet.

According to the present invention, obviating the aforesaid deviations is obtained by utilizing software tools for modifying an interlaced file, prior to its being printed on a lenticular sheet, in accordance with an actual location/position of the lenticular sheet with respect to a known reference point(s)/line(s), or reference marks, and in accordance with the actual pitch distance of the lenticular sheet. The term ‘modifying’ refers to changes that are made to digital data residing within the original interlaced file, or within a copy thereof, which represents the interlaced images, in response to the aforesaid deviations.

With respect to the alignment deviations, the modification involves causing translation and/or rotation of the interlaced images, with respect to the lenticular sheet, until there is essentially no deviation between the interlaced images and a known reference. With respect to the pitch distance, the modification involves stretching and/or compressing the interlaced images, in order to adapt the pitch distance of the interlaced images to the pitch distance of the lenticular sheet.

The method for obtaining automatic alignment of interlaced images to a lenticular sheet and adaptation between the pitch distance thereof comprises:
a) Obtaining an interlaced file that includes digital data that corresponds to linear frames of at least two different images. The digital data comprises linear orientation and pitch distance data;
b) Providing a lenticular sheet, on the flat face of which the at least two different images are intended to be printed, and obtaining linear orientation and pitch distance thereof;
c) Modifying the digital data of the interlaced file so that the orientation and pitch distance of the linear frames match the orientation and pitch distance of the lenticular display sheet; and
d) Printing the modified digital data on the lenticular display sheet.

According to a preferred embodiment of the invention, the linear orientation and pitch distance data is taken relative to a reference position on the lenticular sheet.

Preferably the modifications are made on a digital file that is a copy of the interlaced file, for allowing further utilization of the original interlaced file for additional prints, by avoiding corruption of the original interlaced file.

According to a preferred embodiment of the invention, obtaining the linear orientation and pitch distance of the lenticular sheet is implemented by utilization of:

(i) guiding line(s) and/or reference mark(s), being part of said lenticular sheet or printed on the flat side of said lenticular display sheet; and

(ii) an optical system, capable of moving in line(s) that is/are essentially perpendicular to the lenticules of said lenticular sheet, and sensing the relative location of said guiding lines and/or reference marks by scanning said lenticular sheet and deriving said linear orientation and said pitch distance via the scanning results.

According to an aspect of the invention, the guiding lines, or reference marks, are the first and the last lenticules of the lenticular sheet (hereinafter referred to as the “first and last reference lenticules”, respectively), and the optical system and lenticular sheet are moved relative to one another, for obtaining the “X” and “Y” coordinates of three or more key points. At least two key points reside on the first, or last, reference lenticule and the other key point(s) reside on the last, or first, reference lenticule. Obtaining the “X” and “Y” coordinates of the three or more key points can be affected, e.g., by moving a light source of the optical system over the first and last lenticules, and sensing the difference in the intensity of the light reflected from the vicinity of the first and last lenticules. The obtained “X” and “Y” coordinates of the key points are used to calculate the linear orientation and pitch distance of the lenticular sheet.

By ‘key point’ it is meant herein a crossing point that is obtained by moving the optical scanner of the optical system across a guiding line. The ‘crossing’ point may be arbitrary, because knowing any two (arbitrary) points on the same line allows to find the geometrical equation of the line, and, thereby, the rotational deviation of this line from a reference line. Defining the position/orientation of the lenticular sheet involves the use of simple geometrical rules on at least three key points, not all of them residing on the same line. Having a prior knowledge of the general dimensions and location of the lenticular sheet with respect to the printer, the optical sensor may be programmed to cross guiding lines at preferred section(s) thereof.

Alternatively, part or all the lenticules of the lenticular display sheet are used as guiding lines, or reference marks, to allow the counting of the lenticules as well as measuring the width of the lenticular sheet. The counting of the lenticules and the measuring of the width of the lenticular sheet are allowable by moving a corresponding light source over the lenticules, emitting light towards the lenticules and sensing reflected light having different intensities at different locations as a result of reflections from different portions/areas of the lenticules. Knowing the number of lenticules and width of the lenticular sheet, as described herein above, allows calculating an average pitch distance of the lenticules, by dividing the overall width of the lenticular sheet by the number of the lenticules. According to another preferred embodiment of the invention, the guiding lines, or reference marks, are areas in the lenticular sheet not occupied by lenticules.

According to still another preferred embodiment of the invention, the guiding lines/reference marks are paint marks with distinguishable color(s) applied to preselected portion(s)/area(s) of the lenticular display sheet.

According to yet another aspect of the invention, the guiding lines/reference marks are lenticules that are characterized by having a higher profile and/or larger width with respect to the other lenticules of the lenticular display sheet.

In one instance, the location and position of the lenticular sheet with respect to the printer, and the width of the lenticular sheet are obtained automatically prior to the printing of the interlaced images, by:
a) advancing the lenticular display sheet to a first measuring position;
b) moving the scanning head of the optical system across the guiding line(s), for obtaining key points that are part of the guiding lines;
c) storing the key points in a memory;
d) advancing the lenticular display sheet to a second measuring position and repeating steps b) and c), thereby obtaining additional key point(s); and
e) obtaining the location/position and the width of the lenticular display sheet by utilizing the stored key points.

According to the present invention a printing system is also provided, in which alignment of interlaced images to a lenticular sheet and adaptation between the pitch distance thereof are obtained automatically. The printing system comprises:
a) A printing means, for accepting a lenticular sheet that includes guiding line(s) and/or reference mark(s) as part of the lenticular sheet or printed on the flat side of the lenticular sheet, and for printing the interlaced images on the lenticular sheet;
b) An optical scanner, capable of relative movement with respect to the lenticular sheet, and of scanning the lenticules of the lenticular sheet and of sensing light reflected therefrom, thereby obtaining the ‘X/Y’ coordinates of key points residing on guiding lines, or reference marks, that are part of the lenticular sheet;
c) A computerized system, which includes a software for:
   (c.1) generating a file that is a copy of the original interlaced file;
   (c.2) calculating the alignment deviation of said lenticular sheet from a known reference location/position and the pitch distance of the lenticular sheet, by utilizing said key points;
   (c.3) modifying the data residing within the copy of the original interlaced file in accordance with the calculated alignment deviation and in accordance with the calculated pitch distance deviation; and
   (c.4) printing the modified interlaced file.

Alternatively, step (c.1) can be avoided and modifications can be affected directly on the original file.

The computerized system may be embedded, coupled to, incorporated or integrated into the printing means. Alternatively, the computerized system may be a “stand-alone” system, which is external to the printing means and functionally connected thereto.

Preferably, the computerized system is capable of importing the original interlaced file to the printer. Alternatively, or additionally, the computerized system is capable of generating the original interlaced file.

According to one preferred embodiment of the present invention, the optical scanner is stationary with respect to the lenticular sheet, said optical scanner including a matrix of light sources and a matrix of light sensors, the operation of which replaces the relative movement between said optical scanner and said lenticular sheet, said light sources emitting light in synchronization with respect to one another, for emitting a single beam that moves over several of the lenticules of the lenticular sheet, said moving beam causing corresponding reflection of light from the lenticules of lenticular sheet, which is sensed by said matrix of light sensors, thereby obtaining the key points.

The optical system may be originally embedded, coupled to, incorporated or integrated into the printing means, or be an ‘add-on’ device.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIGS. 1 to 4 schematically illustrate steps in one method of creating an interlaced image;

FIG. 5 shows the interlaced (composite) image created according to the method shown in FIGS. 1 to 4;

FIGS. 6a and 6b schematically illustrate the problem of the offset and tilt/rotation angle misalignment existing between an interlaced file and a lenticular sheet;

FIG. 6c schematically illustrates the problem of mismatch between the pitch distances of the interlaced file and lenticular sheet;

FIGS. 7a and 7b schematically illustrate the measurement principle used for obtaining key points in the lenticular sheet, according to one preferred embodiment of the present invention;

FIG. 8 schematically illustrates an exemplary mechanical arrangement of a scanning system, according to one preferred embodiment of the present invention;

FIG. 9 schematically illustrates an optical scanner according to another embodiment of the present invention; and

FIG. 10 schematically illustrates an exemplary mechanical arrangement of a scanning system, according to another preferred embodiment of the present invention.

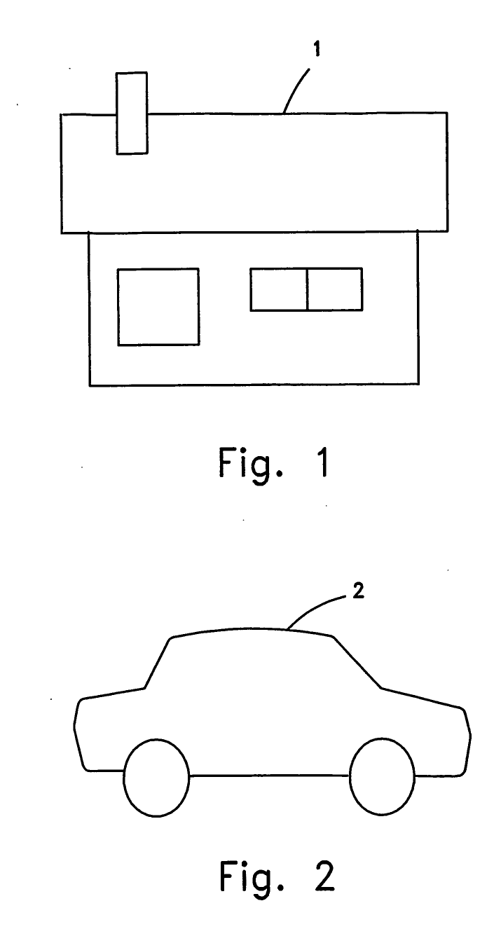

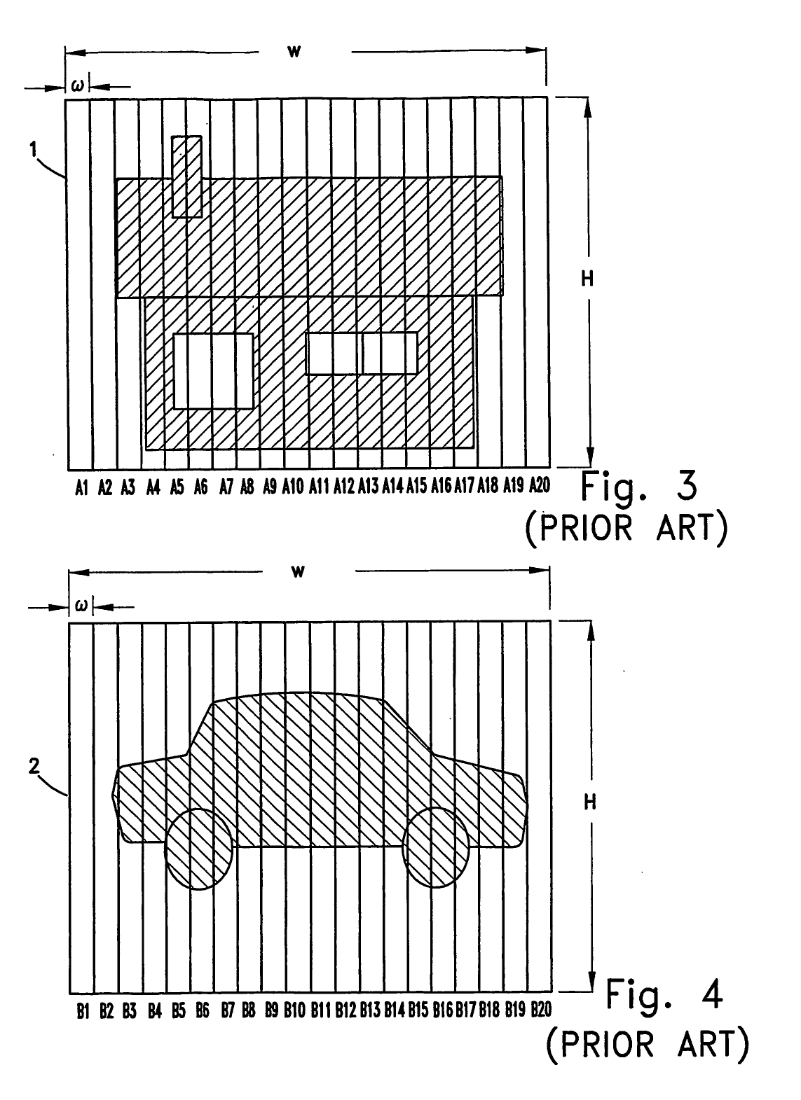

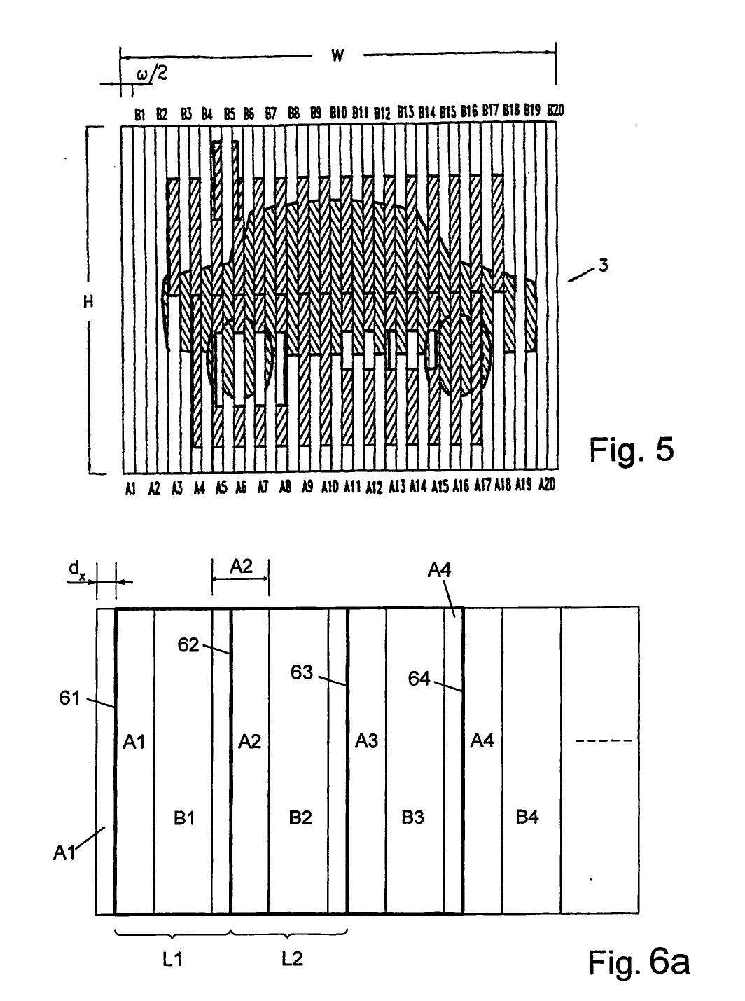

### DETAILED DESCRIPTION OF PREFERRED EMBODIMENTS

The fundamental requirements of a lenticular display are the following:
1. The pitch distance of the interlaced image must be essentially equal to the pitch distance of the lenticules.
2. The distance between the interlaced image and the lenses must be constant and essentially equal to the focal length of the lenses.
3. Exact alignment between the strips of which the interlaced images are comprised, and the array of lenticules must be established and maintained. In the case of the interlaced images shown in the figures, the long axis of the printing on the back of the lenticular sheet must be essentially parallel to the long axis of the cylindrical-like lenses (i.e., lenticules).

These requirements and conventional methods of satisfying them are well known in the art and will not be further discussed herein for the sake of brevity.

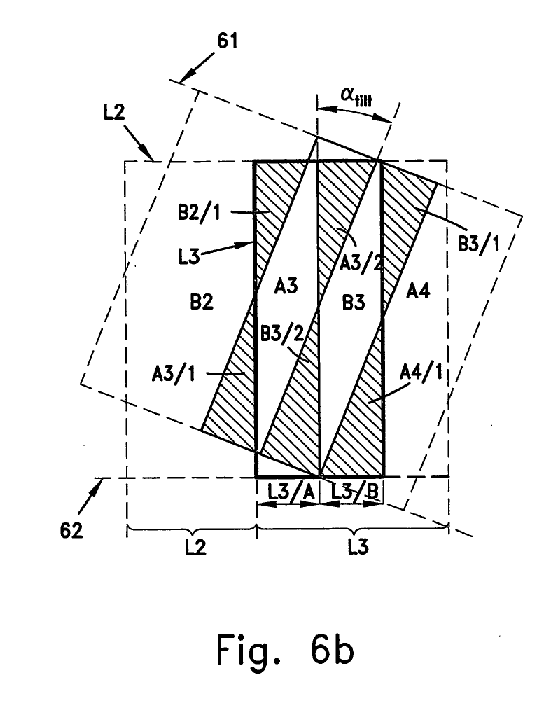

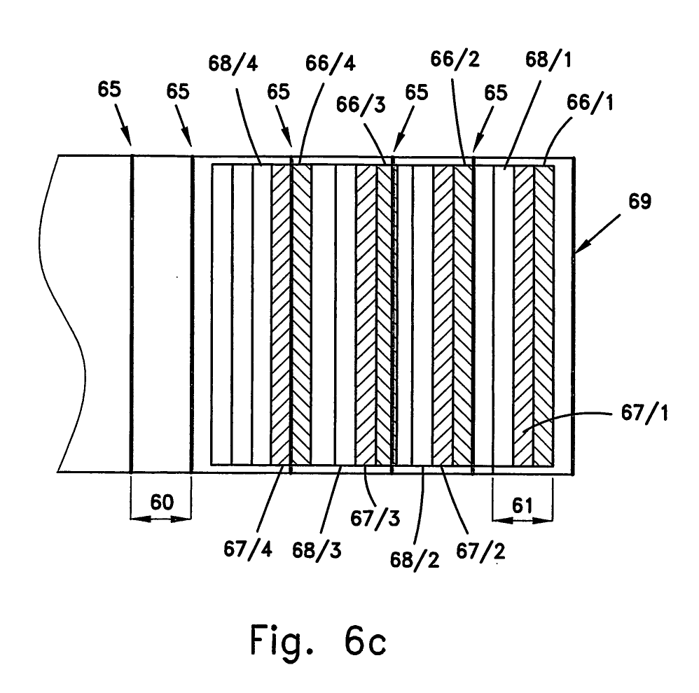

FIG. 6a schematically illustrates an exemplary offset (or translation) misalignment existing between interlaced images printed on the back of the lenticular sheet and the lenticules of the lenticular sheet. The vertical lines of the lenticular sheet (of which only lines 61 to 64 are shown) are parallel to those of the picture/image strips (of which only A1 to A4, and B1 to B4 are shown). However, as a result of a translation “dx” between them, each one of the strips has a picture portion (with width “dx”) that is unintentionally printed on the back of an adjacent lenticule lens. For example, only strips A2 and B2 should have been printed on the back of lenticule lense L2; i.e., the area under lenticule lens L2 should have been occupied only by strips A2 and B2. However, due to the offset “dx”, a portion of strip A2 has “shifted” into lenticule lens L1, and a portion of lenticule lens L2 is unintentionally occupied by a portion of strip A3. This type of misalignment (i.e., the translation) does not pose severe distortions on the resulting printing, because an existing offset will only cause a change in the angles at which a viewer might see the various interlaced images.

FIG. 6b schematically illustrates an exemplary tilt (or rotational) misalignment existing between interlaced images and a lenticular sheet. Interlaced images 61 and lenticular sheet 62 are rotated, with respect to one another, by an angle αₜᵢₗₜ. There are, in general, three basic types of “image distortions”, related to individual lenticules, which are caused by rotational misalignment: (1) lose of relevant image content, (2) adding irrelevant image content, and (3) “inter-exchange” of image content. The distortions, caused by the aforesaid misalignments, greatly spoil the desired visual effect.

FIG. 6c schematically illustrates an exemplary mismatch of pitch distance. Three interlaced images (i.e., 66, 67 and 68) are printed on lenticular sheet 69, for being visualized from three different angles (not shown). Image 66 consists of strips 66/1, 66/2, etc. Likewise, images 67 and 68 consist of strips 67/1, 67/2 etc, and 68/1, 68/2 etc, respectively. Junctures 65 are the boundaries of the corresponding lenticules, and the width of a lenticule (60) is the pitch distance of the lenticular sheet. Reference numeral 61 denotes the pitch distance of the interlaced images. As is shown in FIG. 6c, strips 66/1, 77/1 and 68/1, are rather aligned with the corresponding lenticule, i.e., strips 66/1, 67/1 and 68/1 occupy the right, middle and left portions, respectively, of the lenticule. However, due to a mismatch existing between the pitch distance of the interlaced images and the pitch distance of the lenticules, the strips in the other lenticules shift to other portions of the lenticules. For example, strip 68/4, which belongs to the same image as strip 68/1) shifted to the right portion of the lenticule. Due to a cumulative pitch deviation or error, strips 66i, 67/i and 68/i (i=1, 2, 3, etc.) alternately occupy different portions of the lenticules, thereby causing a major distortion of the interlaced images.

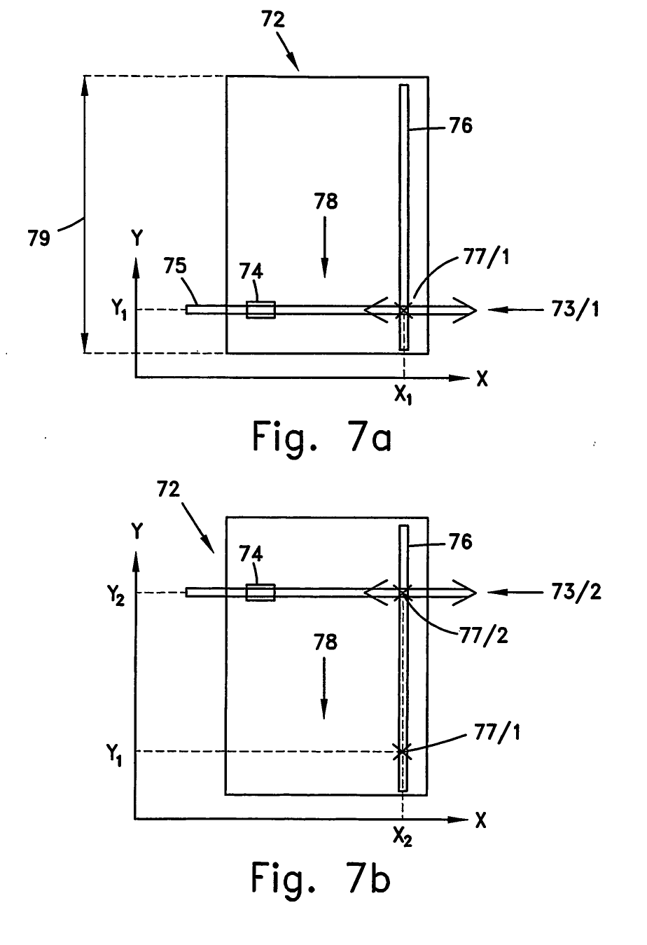

FIGS. 7a and 7b schematically illustrate the measurement of the alignment deviation by utilizing the rightmost lenticule of a lenticular sheet. Optical scanner 74 includes a light source and a light sensing device (not shown). The light source emits light towards the lenticules of lenticular sheet 72, and the light sensing device senses light that is reflected from the lenticules. Basically, optical scanner 74 operates in way similar to a barcode scanner. After initiation of a measurement session by a user/operator of the printer, lenticular sheet 72 is automatically advanced inside the printer (not shown) in a forward direction (78), from its initial position to a first preferred measuring position 73/1. The advancement of the lenticular sheet could be, for example, 20% of the overall length of the lenticular sheet (79). Then, optical scanner 74 is moved back and forth, on rail 75, so as to cause it to cross the rightmost lenticule 76, to obtain key point 77/1, by sensing the X1 coordinate thereof.

Measuring point 77/2 is obtained in the same manner; i.e., the lenticular sheet 72 is further advanced, in forward direction (78), to a second preferred measuring position 73/2, and the optical scanner 74 is moved back and forth, on rail 75, so as to cause it to cross again the rightmost lenticule 76, to obtain key point 77/1 (i.e., the X2 coordinate thereof).

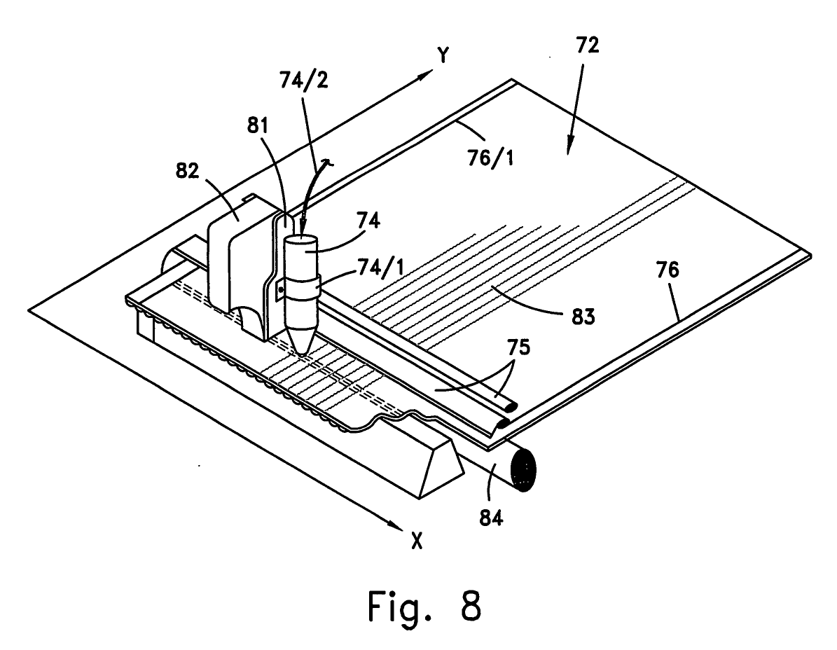

The printing head of the printer (not shown) can be adapted to allow optical scanner 74 to be incorporated into it. Alternatively, scanner 74 can be externally affixed to a standard printing head, as shown in FIG. 8. The optical scanner 74 can be tilted (i.e., with respect to lenticular sheet 72) for maximizing the intensity differences of light that is reflected from different portions/areas of the lenticules. The intensity differences are utilized for obtaining the width of individual lenticules.

Referring again to FIGS. 7a and 7b, the rotational deviation is obtained by utilizing the difference between x1 and x2, and the distance made by the optical scanner 74 between y1 and y2 (i.e., the distance between points 77/1 and 77/2 along the “Y” axis). In addition, the width of the lenticule, from which the pitch distance of the lenticule is derived, can be obtained by moving the optical scanner, one or more times, over the rightmost lenticule, and sensing the light that is reflected from different portions/areas of the lenticule and having, therefore, different intensities, which may be correlated to the corresponding width.

Of course, additional key points can be obtained by employing the above-described procedure on the same and/or additional lenticules. For example, two key points can be obtained, which reside on the leftmost lenticule. The four key points (i.e., two on the rightmost lenticule, and two on the leftmost lenticule) permit to obtain a more accurate alignment deviation, and also the width of the lenticular sheet, which can be utilized for matching the pitch distances.

According to a preferred embodiment of the invention, lenticule 76 can be replaced by an empty space residing between two lenticules. The width of the empty space may equal the width of a lenticule, though this is not compulsory.

According to another preferred embodiment of the invention, lenticule 76 may have different dimensions with respect to the other lenticules of lenticular sheet 72. For example, lenticule 76 may be wider/narrower and/or have higher/lower profile.

After completing the measurement session, lenticular sheet 72 is retracted to its initial position, after which the digital data in the interlaced file is modified according to the calculated alignment and pitch distance deviations, and the modified interlaced file may be printed.

FIG. 8 schematically illustrates an exemplary mechanical arrangement of a scanning system, according to a preferred embodiment of the present invention. Lenticular sheet 72 includes lenticules 83 (only a few of which are shown), which are observable through the transparent substance of lenticular sheet 72 and co-aligned with the advancement direction of lenticular sheet 72. Detachable printing head 82 is attached to carrier 81 that is movable on rail 75. Optical scanner 74 is coupled to carrier 81 by using, e.g., coupling device 74/1. Electric cable 74/2 includes wires for providing power to the light source in optical scanner 74, and wires for forwarding to a computerized system electrical signals that correspond to the sensed reflected light, for translation of the electrical signals into the corresponding width of individual lenticules. Reference numerals 76 and 76/1 denote the rightmost and leftmost lenticules, respectively, that are utilized, according to a particular embodiment of the present invention, as reference lenticules. Of course, optical scanner 74 can be mounted on a different side of carrier 81. Roller 83 that is mechanically coupled to a motor, used to move lenticular sheet 72 back and forth during the measurement sessions and to advance lenticular sheet 72 forward in the printing stage.

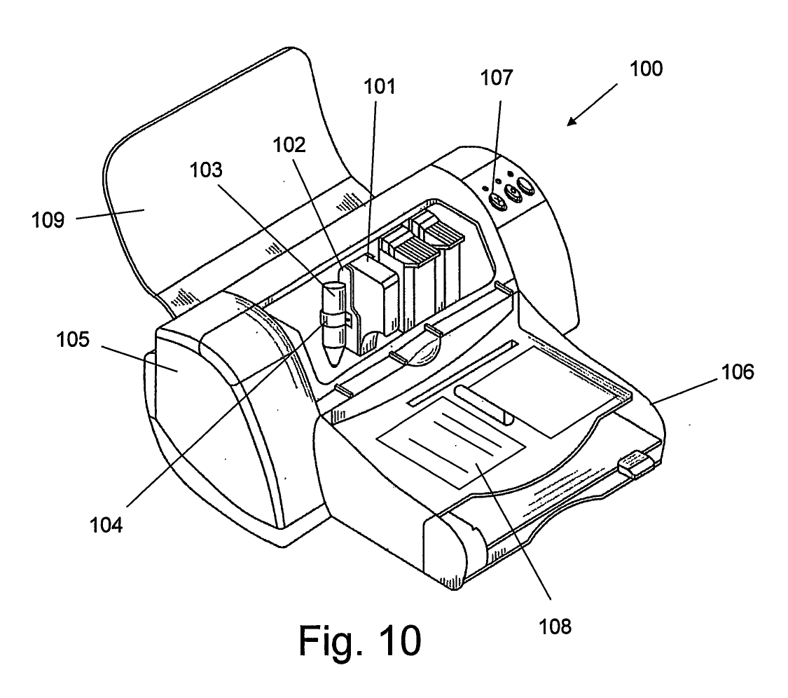

Optical scanner 74 can be utilized, mutatis mutandis, in an ink jet or bubble jet (or other) printer, as shown in FIG. 10.

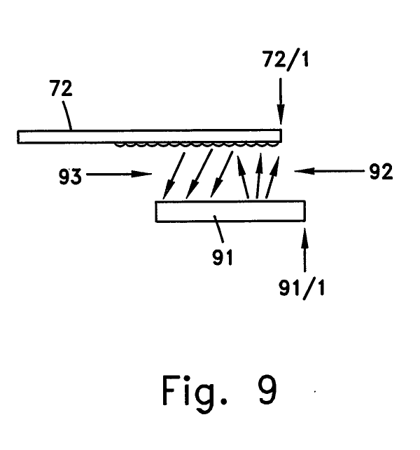

FIG. 9 schematically illustrates another type of optical scanner, according to preferred embodiment of the present invention. Unlike optical scanner 74 (shown, for example, in FIG. 8), which is mobile, optical scanner 91 is stationary and includes a matrix of light sources (not shown) and a matrix of light sensors (not shown). Having the light sources in the matrix emitting light in synchronization a beam of light is formed, which scans (92) the rightmost and/or leftmost lenticules of lenticular sheet 72. A corresponding reflection of light (93) is sensed by the matrix of light sensors, which is utilized for identifying the rightmost, or leftmost, lenticule and for obtaining the width thereof and, possibly, the width of adjacent lenticules. The rightmost end 91/1 of optical scanner 91 is positioned further left than the leftmost side 72/1 of lenticular sheet 72 for ensuring that the leftmost lenticule of lenticular sheet 72 is identified by optical scanner 91.

The reference location/position described above is determined once, preferably at the time the printer is manufactured and stored, but re-alignment procedures can, of course, also be carried out later.

FIG. 10 schematically illustrates an exemplary mechanical arrangement of a scanning system according to another preferred embodiment of the present invention. Printer 100 can be a combination of a conventional printer 105 and an optical scanner 103 used as an ‘add-on’ device.

Alternatively, printer 100 can be originally designed with optical scanner 103 as one of its integral components.

Detachable printing head 101 is attached to carrier 102, which is movable on a rail (not shown). Optical scanner 103 is coupled to carrier 102 by using, e.g., coupling device 104. Lenticular sheet 108 is put in paper tray 106 just like any other normal printing paper. Printer 100 may include means for automatically distinguishing between a paper sheet and a lenticular sheet, in order to avoid performing the measurement session as described above, when not needed. Optionally, printer 100 may include other means, such as pushbutton 107, for inputting printer 100 data indicating that the current sheet 108 in paper tray 106 is a lenticular sheet. Reference numeral 109 denotes the cover of printer 100.

Although embodiments of the invention have been described by way of illustration, it will be understood that the invention may be carried out with many variations, modifications, and adaptations, without departing from its spirit or exceeding the scope of the claims.

1. A method for obtaining automatic alignment of interlaced images to a lenticular sheet and adaptation between the pitch distance thereof, comprising:
a) Obtaining an interlaced file that includes digital data corresponding to linear frames of at least two different images, said digital data comprising linear orientation and pitch distance data;
b) Providing a lenticular sheet, on the flat face of which said at least two different images are intended to be printed, and obtaining linear orientation and pitch distance thereof;
c) Modifying the digital data of the interlaced file so that the orientation and pitch distance of said linear frames match the orientation and pitch distance of said lenticular sheet; and
d) Printing the modified digital data on said lenticular sheet.

2. A method according to claim 1, wherein the linear orientation and pitch distance data is taken relative to a reference position on the lenticular sheet.

3. A method according to claim 1, wherein the modifications are made on a digital file that is a copy of the interlaced file, for allowing further utilization of the original interlaced file for additional prints, by avoiding corruption of the original interlaced file.

4. A method according to claim 1, wherein obtaining the linear orientation and pitch distance of the lenticular sheet is implemented by utilization of:
(i) guiding line(s) and/or reference mark(s), being part of said lenticular sheet or printed on the flat side of said lenticular sheet; and
(ii) an optical system, capable of moving in line(s) that is/are essentially perpendicular to the lenticules of said lenticular sheet, and sensing the relative location of said guiding lines and/or reference marks by scanning said lenticular sheet and deriving said linear orientation and said pitch distance via the scanning results.

5. A method according to claim 4, wherein the guiding lines, or reference marks, are the first and the last lenticules of the lenticular sheet and the optical system and lenticular sheet are moved relative to one another for obtaining the “X” and “Y” coordinates of three or more key points, at least two key points residing on said first, or last, lenticule and the other key point(s) on said last, or first, lenticule, by moving a light source over the first and last lenticules, and sensing the difference in the intensity of the light reflected from the vicinity of said first and last lenticules, and the obtained “X” and “Y” coordinates of said key points being used to calculate the linear orientation and pitch distance of said lenticular sheet.

6. A method according to claim 4, wherein part or all of the lenticules of the lenticular sheet are used as guiding lines, or reference marks, to allow the counting of the lenticules as well as measuring the width of said lenticular sheet, by moving a corresponding light source over the lenticules, emitting light towards the lenticules and sensing reflected light having different intensities at different locations as a result of reflections from different portions/areas of the lenticules, thereby calculating an average pitch distance of said lenticules, by dividing the overall width of said lenticular sheet by the number of said lenticules.

7. A method according to claim 4, wherein the lenticular sheet contains areas not occupied by lenticules, and wherein the guiding lines, or reference marks, are said areas.

8. A method according to claim 4, wherein the guiding lines/reference marks are paint marks with distinguishable color(s) applied to preselected portion(s)/area(s) of the lenticular sheet.

9. A method according to claim 4, wherein the guiding lines/reference marks are lenticules that are characterized by having a higher profile and/or larger width with respect to the other lenticules of the lenticular sheet.

10. A method according to claim 4, wherein the location/position of the lenticular sheet with respect to the printer, and the width of said lenticular sheet is obtained automatically prior to the printing of the interlaced images, comprising:
a) advancing said lenticular sheet to a first measuring position;
b) moving the scanning head of the optical system across the guiding line(s), for obtaining key points that are part of said guiding lines;
c) storing said key points;
d) advancing said lenticular sheet to a second measuring position and repeating steps b) and c); and
e) obtaining the location/position and the width of said lenticular sheet by utilizing the stored key points.

11. A printing system in which alignment of interlaced images to a lenticular sheet and adaptation between the pitch distance thereof are obtained automatically, comprising:
a) A printing means, for accepting a lenticular sheet that includes guiding line(s) and/or reference mark(s) as part of said lenticular sheet or printed on the flat side of said lenticular sheet, and for printing the interlaced images on said lenticular sheet;
b) An optical scanner, capable of relative movement with respect to said lenticular sheet, and of scanning the lenticules of said lenticular sheet and of sensing light reflected therefrom, thereby obtaining the ‘X/Y’ coordinates of key points residing on guiding lines, or reference marks, that are part of said lenticular sheet;
c) A computerized system, which includes a software for:
(c.1) generating a file that is a copy of the original interlaced file;
(c.2) calculating the alignment deviation of said lenticular sheet from a known reference location/position and the pitch distance of the lenticular sheet, by utilizing said key points;
(c.3) modifying the data residing within the copy of the original interlaced file in accordance with the calculated alignment deviation and in accordance with the calculated pitch distance deviation; and
(c.4) printing the modified interlaced file.

12. A printing system according to claim 11, in which the computerized system is embedded, coupled to, incorporated or integrated into the printing means.

13. A printing system according to claim 11, in which the computerized system is a “stand-alone” system, which is external to the printing means and functionally connected thereto.

14. A printing system according to claim 11, in which the computerized system is capable of importing the original interlaced file to the printer.

15. A printing system according to claim 11, in which the computerized system is capable of generating the original interlaced file.

16. A printing system according to claim 11, in which the optical scanner is stationary with respect to the lenticular sheet, said optical scanner including a matrix of light sources and a matrix of light sensors, the operation of which replaces the relative movement between said optical scanner and said lenticular sheet, said light sources emitting light in synchronization with respect to one another, for emitting a single beam that moves over several of the lenticules of the lenticular sheet, said moving beam causing corresponding reflection of light from the lenticules of lenticular sheet, which is sensed by said matrix of light sensors, thereby obtaining the key points.

17. A printing system according to claim 11, in which the optical system is originally embedded, coupled to, incorporated or integrated into the printing means, or is an ‘add-on’ device.
